(19) United States
(12) Patent Application Publication
(10) Pub. No.: US 2010/0174853 A1
(43) Pub. Date: Jul. 8, 2010

(54) USER DEVICE INCLUDING FLASH AND RANDOM WRITE CACHE AND METHOD WRITING DATA

(75) Inventors: Joon-ho LEE, Hwaseong-si (KR); Jun-Ho JANG, Seoul (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: Samsung Electronics Co., Ltd., Suwon-si (KR)

(21) Appl. No.: 12/603,687

(22) Filed: Oct. 22, 2009

(30) Foreign Application Priority Data
Jan. 8, 2009 (KR) 10-2009-0001553

(51) Int. Cl. G06F 12/02

(52) U.S. Cl. 711/103; 711/E12.008

(57) ABSTRACT

A method of writing data to a flash memory in a system includes; receiving write data to be written in the flash memory, determining whether the received write data is random write data or sequential write data, if the received write data is sequential write data, then directly writing the received write data to the flash memory, and if the received write data is random write data, then writing the received write data to the random write cache, and flushing the random write data from the random write cache to the flash memory during idle periods for the flash memory.

### CROSS-REFERENCE TO RELATED APPLICATIONS

This U.S. non-provisional patent application claims priority under 35 U.S.C §119 to Korean Patent Application No. 10-2009-0001553 filed on Jan. 8, 2009, the subject matter of which is hereby incorporated by reference.

### BACKGROUND

The present inventive concept relates to semiconductor memory devices. More particularly, the inventive concept relates to a user device including a flash memory, a cache memory, and a controller.

A wide variety of semiconductor memory devices are used to store data in constituent host devices. Semiconductor memory devices may be classified as volatile and non-volatile in their operation. A volatile memory device loses stored data in the absence of applied power. Common volatile memory devices include SRAM, DRAM, SDRAM, and the like.

In contrast, a non-volatile memory device retains stored data in the absence of the applied power. Common non-volatile memory devices include ROM, PROM, EPROM, EEPROM, flash memory, PRAM, MRAM, RRAM, FRAM, and the like. The flash memory may be further classified as NOR type or NAND type.

### SUMMARY

Embodiments of the inventive concept provide a user device having an improved random write function.

In one embodiment, the inventive concept provides a user device comprising; a flash memory, a random write cache, and a processor connected via a system bus. The processor is configured to control operation of the flash memory and the random write cache, and further configured to receive write data to be written in the flash memory, determine whether the received write data is random write data or sequential write data, if the received write data is sequential write data, then directly writing the received write data to the flash memory, and if the received write data is random write data, then writing the received write data to the random write cache, and flushing the random write data from the random write cache to the flash memory during idle periods for the flash memory.

In another embodiment, the inventive concept provides a method of writing data to a flash memory in a system, the system comprising the flash memory, a random write cache, and a processor connected via a system bus, the method comprising; receiving write data to be written in the flash memory, determining whether the received write data is random write data or sequential write data, if the received write data is sequential write data, then directly writing the received write data to the flash memory, and if the received write data is random write data, then writing the received write data to the random write cache, and flushing the random write data from the random write cache to the flash memory during idle periods for the flash memory.

### BRIEF DESCRIPTION OF THE DRAWINGS

Non-limiting and non-exhaustive embodiments will be described with reference to the accompanying drawings. Throughout the drawings and written description that follows, like reference numbers and labels refer to like or similar elements, unless otherwise specified. In the drawings:

FIG. 1 is a block diagram of a user device according to an embodiment of the inventive concept.

FIG. 2 is a block diagram further illustrating the user device of FIG. 1.

FIG. 3 is a flowchart summarizing a method of operating the user device 100 of FIGS. 1 and 2 according to an embodiment of the inventive concept.

FIGS. 4-6 further illustrate the user device 100 of FIGS. 1 and 2 showing the transfer of various data types during operation according to an embodiment of the inventive concept.

FIG. 7 is a flowchart summarizing a method of performing a flush operation within the context of the user device according to an embodiment of the inventive concept.

FIG. 8 further illustrates the user device 100 of FIGS. 1 and 2 showing the transfer of various data types during operation according to an embodiment of the inventive concept.

FIG. 9 is a block diagram of a user device according to another embodiment of the inventive concept.

FIG. 10 further illustrates the user device 100 of FIG. 1 and user device 300 of FIG. 9 showing the transfer of various data types during operation according to an embodiment of the inventive concept.

### DETAILED DESCRIPTION OF THE EMBODIMENTS

Embodiments of the inventive concept will now be described with reference to the accompanying drawings. However, it should be noted that the inventive concept may be variously embodied and is not limited to only the illustrated embodiments. Rather, the illustrated embodiments are presented as teaching examples.

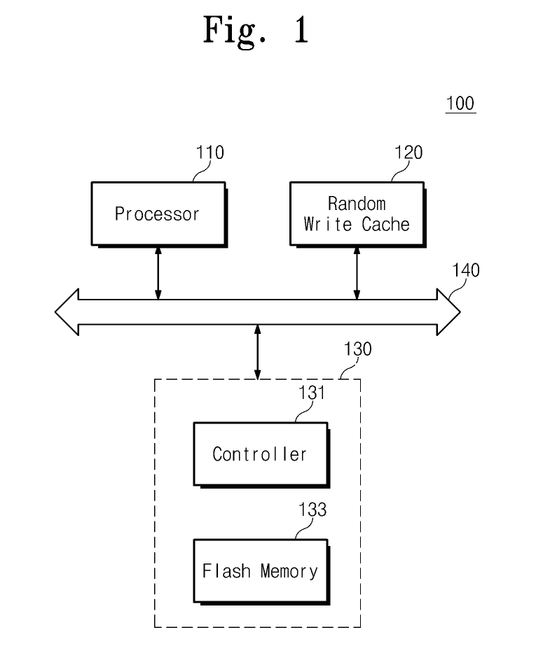

Figure (FIG. 1 is a block diagram illustrating a user device according to an embodiment of the inventive concept. Referring to FIG. 1, a user device 100 comprises a processor 110, a random write cache 120, a memory unit 130, and a system bus 140.

The processor 110 communicates with constituent elements of the user device 100 via the system bus 140. The processor 110 may be configured to control the overall operation of the user device 100. The processor 110 may be further configured to process data and perform operation in relation to the processed data.

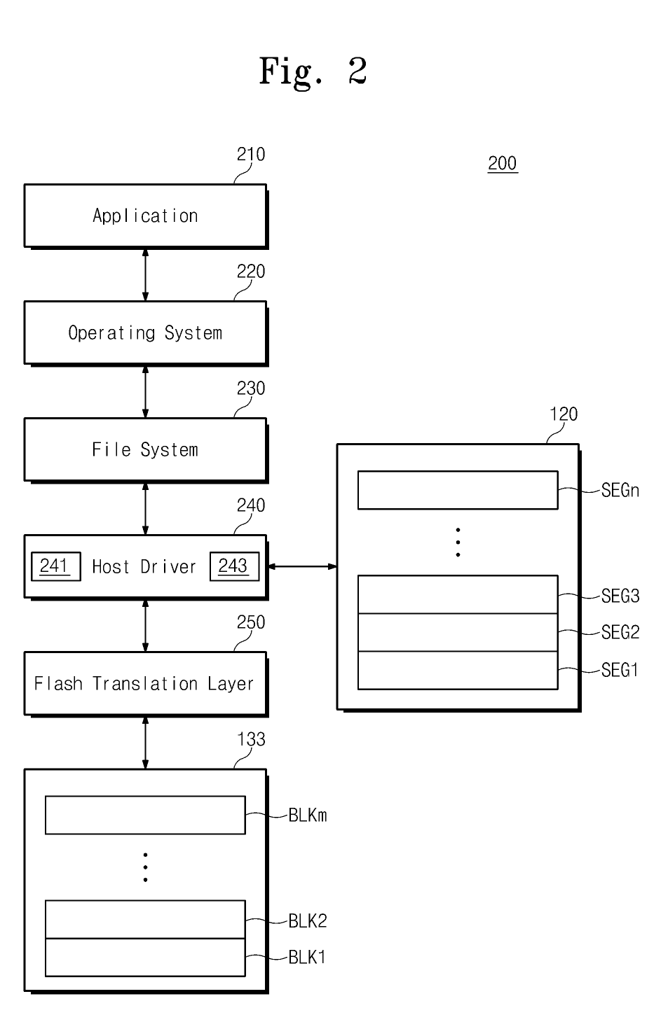

The random write cache 120 communicates with elements of the user device 100 via the system bus 140. The random write cache 120 may be configured to temporarily store “write data” to be written to one or more memory cells in the memory unit 130. In an embodiment of the inventive concept, the random write cache 120 is configured to store random write data within the general class of write data to be stored in the memory unit 130. Operation of the random write cache 120 will be more fully described with reference to FIGS. 2 to 8.

The memory unit 130 also communicates with elements of the user device 100 via the system bus 140. The memory unit 130 may be configured to receive transfer of write data via the system bus 140 in response to a write command received from the processor 110. The memory unit 130 may also be configured to transfer read data via the system bus 140 in response to a read command received from the processor 110.

The system bus 140 essentially provides a channel via which the elements of the user device 100 communicate with one another.

In the illustrated embodiment of FIG. 1, the memory unit 130 comprises a controller 131 and a flash memory 133. The controller 131 is configured to control the operation of flash memory 133. The flash memory 133 may include certain conventionally understood elements, such as a memory cell array, an address decoder, a page buffer (or, a page register), a sense amplifier, a column selector, a data input/output circuit, a write driver, and the like.

The flash memory 133 may perform a write operation by a page unit. In one exemplary embodiment, one page may be formed of 2 KB or 4 KB of data. In this case, the flash memory 133 performs a write operation according to a 2 KB or 4 KB unit size. The flash memory 133 may perform an erase operation by a block unit. In one exemplary embodiment, one block includes 64 pages.

The flash memory 133 operates according to an erase-before-write technique. That is, in order to write a specific page of the flash memory 133, an erase operation is required prior to the write operation. However, the write operation of the flash memory 133 is made by a page unit while the erase operation is made by a block unit. Thus, erasing a single page may necessitate erasing an entire block including said page.

In an exemplary embodiment, it is assumed that write data to be written in the flash memory 133 is random write data. The random write data may be data to be written at any region of the flash memory 133. For example, it is assumed that “old data” (e.g., DATA0) has been previously stored in the flash memory 133 and that “new data” (e.g., DATA0_1) updating the old data DATA0 is written in the flash memory 133. Further, it is assumed that the old data DATA0 was stored in a first memory block (e.g., BLK0) of the flash memory 133 and that the new data DATA0_1 is stored in a first page PAGE0 of the first memory block BLK0.

The new data DATA0_1 may be written to the first page PAGE0 of the first memory block BLK0 to update the old data DATA0 already stored in the first page PAGE0 of the first memory block BLK0. In order to write the new data DATA0_1 in the first page PAGE0, and assuming the flash memory 133 operates in an erase-before-write mode, an erase operation must be applied to the entire first memory block BLK0 including the first page PAGE0 before the new data DATA0_1 can be written in the first page PAGE0.

Extending this working assumption, a conventional flash memory device would first copy the data stored in the first memory block BLK0, excepting for data stored in the first page PAGE0 of the first memory block BLK0, into another block (e.g., a copy block BLK0′), and then write the new data into the first page PAGE0 of the copy block BLK0′. The original first block BLK0 would then be designated as an invalid block. As invalid blocks accumulate with repeated random write operations, the conventional flash memory must ultimately perform such restorative operations as garbage collection, merge, and so on. That is, as random write operations are performed, a conventional flash memory must continually perform certain memory space restorative “background operations”. Unfortunately, such background operations increase memory system operating overhead.

In contrast to the foregoing conventional mode of dealing with the size difference between a random write operation and an erase oration, certain embodiments of the inventive concept are configured to write sequential write data directly to the flash memory 133, while writing random write data to the random write cache 120. Then, when the flash memory 133 is in an idle state (e.g., during periods between data access operations), the user device 100 may copy the random write data stored in the random write cache 120 to the flash memory 133. In the description that follows, an operation transferring (or write-copying) the random write data stored in the random write cache 120 to the flash memory 133 will be referred to as a “flush operation”. In the embodiment illustrated in FIG. 1, a flush operation may include the steps of writing the random write data stored in the random write cache 120 to the flash memory 133, and then deleting the random write data from the random write cache 120.

The user device 100 of FIG. 1 may form or be incorporated within, for example, a computer, a portable computer, UMPC, workstation, net-book, PDA, portable computer, web tablet, wireless phone, mobile phone, smart phone, digital camera, digital audio recorder/player, digital picture/video recorder/player, a device for transmitting and receiving information at a wireless circumstance, one of electronic devices constituting home network, one of electronic devices constituting computer network, or one of electronic devices constituting computing system such as Solid State Drive (SSD) or memory card.

The term “sequential write data” means write data to be written into continuous logical addresses or continuous physical addresses within a memory. For example, sequential write data may be data to be written across N continuous logical pages of the flash memory 133, where N is a positive integer. Alternately, sequential write data may be data to be written across N continuous physical pages of the flash memory 133. Sequential write data may be defined with any reasonable size (e.g., bits, bytes, sectors, pages, or blocks).

FIG. 2 is a block diagram further illustrating the user device of FIG. 1 and emphasizing certain software (and related hardware) components of the user device. Referring to FIGS. 1 and 2, a software layer 200 of a user device 100 according to an embodiment of the inventive concept comprises; an application 210, an operating system 220, a file system 230, and a flash translation layer 250. These software layer components are shown in relation to an associated host driver 240, the random write cache 120, and flash memory 133.

The application 210 generally comprises one or more programs capable of being run on the user device 100. For example, the application 210 may comprise one or more programs implementing a document editor, an internet search function, an audio file player, a moving picture player, or the like. Many of the hardware resources necessary to run the application 210 on user device 100 are generally indicated by the processor 110. Those skilled in the art will recognize that many different system resource configurations may be used to enable the application 210,

As is conventionally understood, the operating system 220 is specialized software designed to control the overall operation of hardware and software resources within the user device 100. Conventionally available examples of operating system 220 capable of being incorporated into embodiments of the inventive concept include Windows, Windows CE, Mac OS, Linux, Unix, VMS, OS/2, Solaris, Symbian OS, Palm OS, BSD, DOS, and the like. The processor 110 runs the operating system 220.

Again as is conventionally understood, the file system 230 manages the exchange of data and use of memory space provided by the memory elements of the user device 100, including the flash memory 133. Conventionally available examples of file system 230 capable of being incorporated into embodiments of the inventive concept include FAT, FAT32, NTFS, HFS, JSF2, XFS, ODS-5, UDF, ZFS, UFS, ext2, ext3, ext4, ReiserFS, Reiser4, ISO 9660, Gnome VFS, BFS, WinFS, and the like. The processor 110 runs the file system 230 in conjunction with the operating system 220.

The host driver 240 is a generalized block diagram element for certain conventionally understood circuits and associated hardware (e.g., certain operating system 200 components) used as a driver for the memory unit 130 of user device 100. The processor 110 controls operation of the host driver 240. In the illustrated embodiment of FIG. 2, the host driver 240 comprises a data filter 241 capable of determining whether write data to be sent to the memory unit 130 is sequential write data or random write data. The host driver 240 also comprises a flush controller 243 capable of controlling a flush operation for write data stored in the random write cache 120.

Thus, the host driver 240 is configured to access the random write cache 120. If “received write data” (i.e., data to be written to the flash memory 133) is determined by the data filter 241 to be random write data, then the host driver 240 writes the received write data to the random write cache 120. Later, when the flash memory 133 is idle (i.e., there are no active I/O commands to the flash memory 133), the flush controller 243 of the host driver 240 controls the random write cache 120 to flush the stored random write data from the random write cache 120 to the flash memory 133.

In the illustrated embodiment of FIG. 1, the random write cache 120 is divided into a plurality of segments SEG1 to SEGn. Each one of the plurality of segments SEG1 to SEGn is configured to store random write data, as determined by the data filter 241. During a subsequent flush operation, (i.e., during an otherwise idle time for the flash memory 133), the flush controller 243 may be configured such that random write data is flushed from a number of segments to the flash memory 133. In certain embodiments of the inventive concept, the flush controller 243 of the user device 100 may be configured to adjust the number of “flushed segments”.

The random write cache 120 used within the user device 100 may be implemented using random access memory. For example, the random write cache 120 may be implemented with non-volatile random access memory, such as PRAM, MRAM, FRAM, and the like. Alternatively, the random write cache 120 may be implemented with volatile random access memory, such as DRAM, SRAM, SDRAM, and the like.

As is conventionally understood, the flash translation layer 250 may be used to variously implement one or more mapping functions between physical addresses in the flash memory 133 and corresponding logical addresses defined by the application 210, operating system 220, file system 230, host driver 240, and/or processor 110 during data access operations directed to the flash memory 133. The flash translation layer 250 may be configured to translate logical addresses into physical addresses of the flash memory using the mapping information. In one embodiment of the inventive concept, the flash translation layer 250 is also configured to run during background operations such as flush, garbage collection, merge, and the like. The processor 110 (or a subordinated memory controller, not shown) runs the flash translation layer 250 in conjunction with the operating system 220.

In one embodiment, the flash memory 133 is implemented as a NAND flash memory. The flash memory 133 is divided into a plurality of memory blocks BLK1 to BLKm. Each one of the plurality of the memory blocks BLK1 to BLKm comprises a plurality of pages, and each page comprise a number of memory cells capable of storing M-bit data, where M is a positive integer. The flash memory 133 is assumed to perform write (or program) operations on a page unit basis and erase operations on a block unit basis. The flash memory 133 is further assumed to operate in an erase-before-write mode.

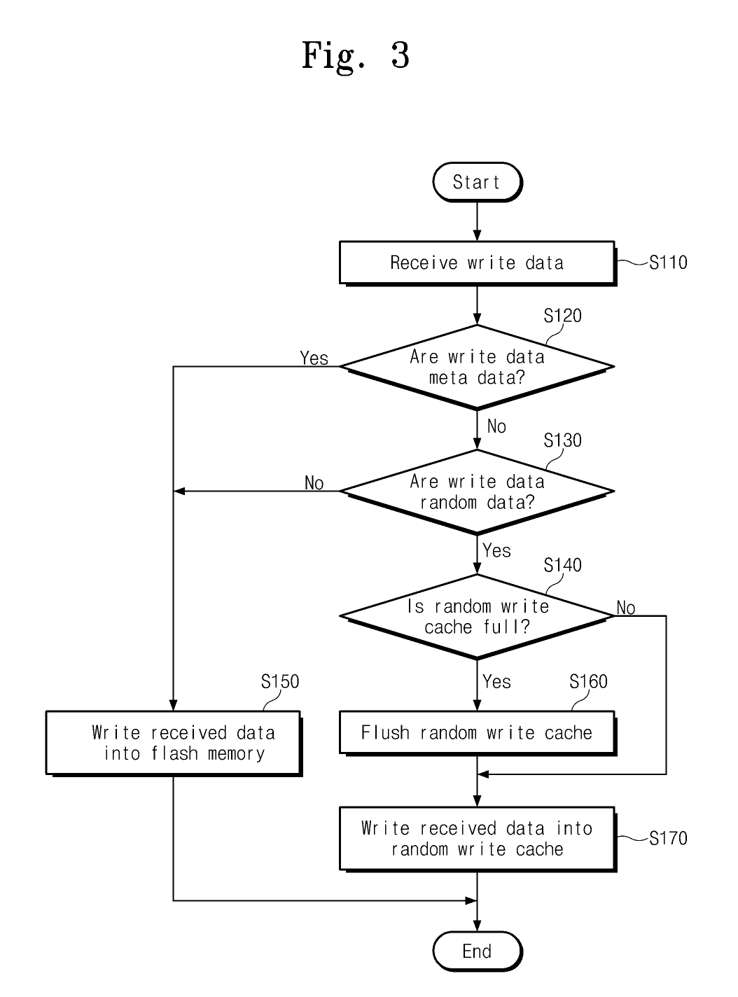

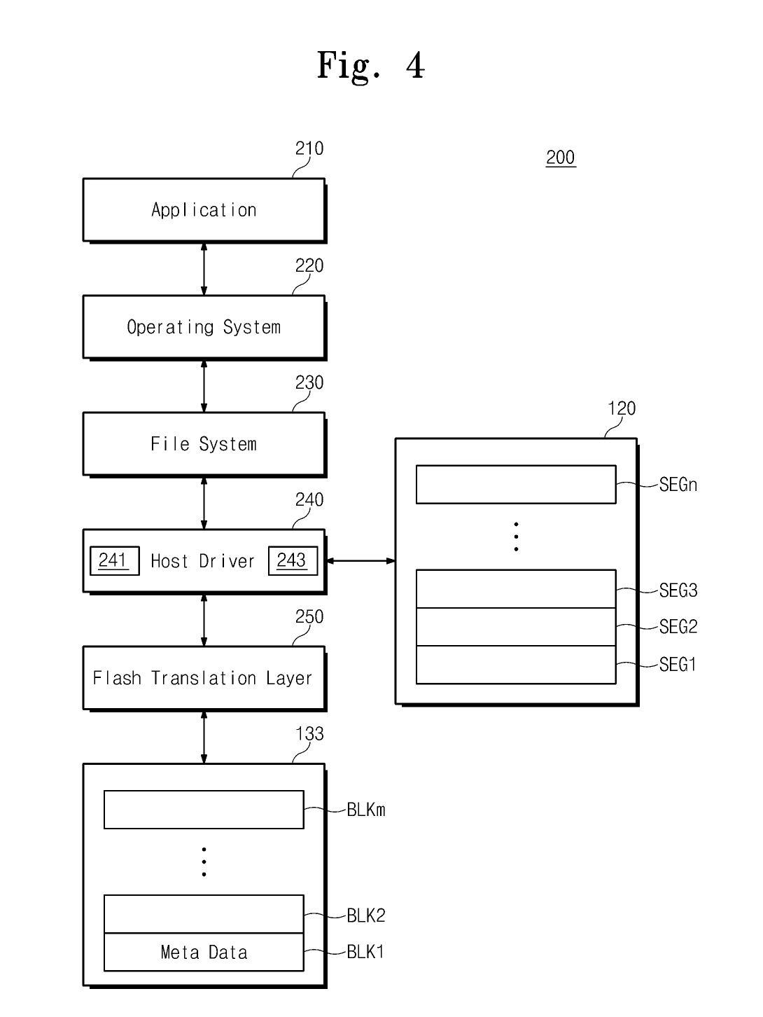

FIG. 3 is a flowchart summarizing a method of operating the user device 100 of FIGS. 1 and 2 according to an embodiment of the inventive concept. FIGS. 4-6 are further illustrations of the user device 100 of FIGS. 1 and 2 showing the transfer of various data types during operation according to an embodiment of the inventive concept.

Referring to FIGS. 1 through 3, the host driver 240 receives write data to be written in a flash memory 133 (S110). Then, the host driver 240 determines whether the received write data is meta data (S120). Meta data is data characterizing the bulk or payload data to be stored in the flash memory 113, as opposed to the actual data to be stored. Next, the host driver determines whether the received write data is random write data or some other type of write data, such as sequential write data (S130). If the host driver 240 determines that the received write data is meta data (S120=YES) or that the received write data is not random data (S130=NO), then the received write data is written directly to the flash memory 133 (S150).

In the event that the random write cache 120 is implemented with volatile memory, the data stored in the random write cache 120 may be lost upon power-off. If the received write data is the meta data, the host driver 240 will directly write the received write data to the flash memory 133, regardless of whether the received write data is sequential write data or random write data. That is, meta data is never treated as random write data in order to prevent the loss of such data upon a sudden power-off.

Referring now to the example illustrated in FIG. 4, it is assumed that first received meta data is directly written to a first memory block BLK1 of the flash memory 133. However, embodiments of the inventive concept are not limited to merely storing meta data in a first memory block BLK1. For example, the flash memory 133 may be divided into a user data region for storing user data and a meta data region for storing meta data. The user data region and the meta data region may be classified by a memory block unit. Alternatively, the user data region and the meta data region may be mixed at a storage space of the flash memory 133 (or, may not be limited to a specific region of the flash memory 133).

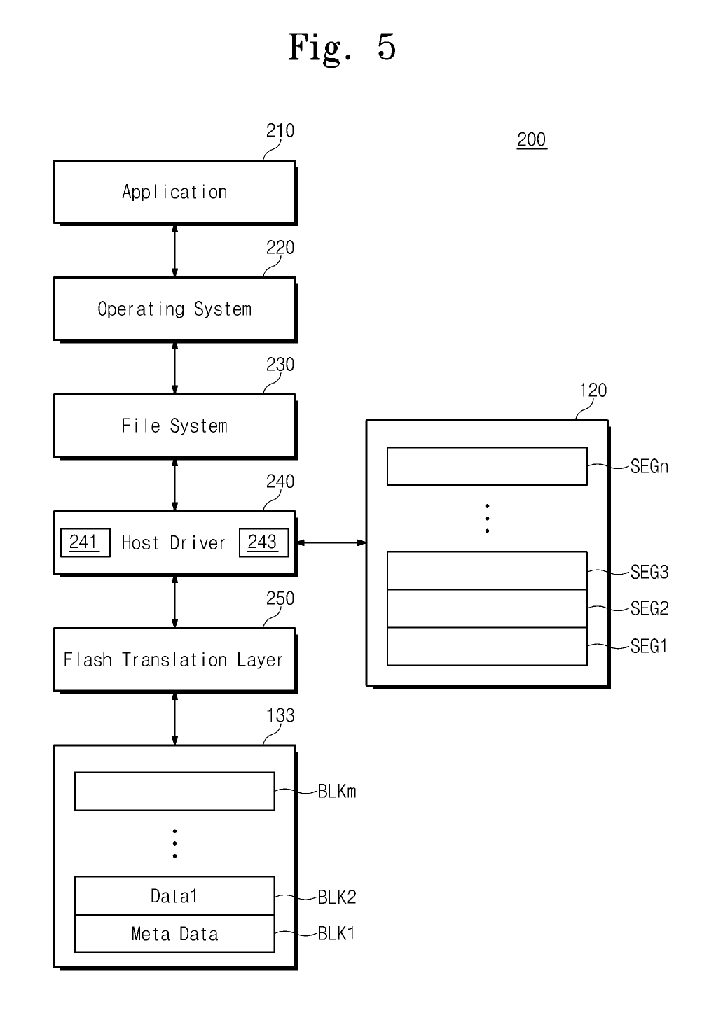

Returning to FIG. 3, if the received write data is determined to not be meta data (S120=NO), the data filter 241 in host driver 240 determines whether the received write data is random write data or sequential write data (S130). If the received write data is not random write data, then it is written directly to the flash memory 133 (S150). FIG. 5 further illustrates an example wherein second received write data (Data1) is determined not to be random write data (S130=NO), and is then directly written to a second memory block (BLK2) of the flash memory 133, after first received write data is determined to be meta data and is written directly to a first memory block (BLK1) of the flash memory 133.

Returning to FIG. 3, if the host driver 240 determines that the received write data is not meta data (S120=NO) and that the received write data is random data (S130=YES), then a determination is made as to whether the random write cache is full (S140). If the random write cache 120 is full (i.e., insufficient available memory space exists to store current received write data) (S140=YES), then the flush controller 243 of host driver 240 is called to perform a flush operation on random write cache 120 (S160).

In one embodiment of the inventive concept, the flush controller 243 flushes data stored in the random write cache 120 on a segment by segment basis (i.e., according to SEG1 to SEGn defined within the random write cache 120) into the flash memory 133. For example, the flush controller 243 may flush data stored in one or more of the plurality of segments SEG1 to SEGn of the random write cache 120 into the flash memory 133, based on flush settings defined by processor 110. Alternately, the flush controller 243 may flush random write data from the random write cache 120 to the flash memory 133 on a segment by segment basis in view of a currently Least Recently Used (LRU) segment definition. The LRU segment is the segment in the random write cache 120 that has least recently been used as determined by a running access time, a use count, etc.

That is, if available memory space exists within the random write cache 120, the flush controller 243 frees up additional memory space by flushing data from at least one segment of the random write cache 120 to the flash memory 133. In certain embodiments of the inventive concept, a current write operation directed to the random write cache 120 may be held pending completion of a flush operation.

Thus, following execution of the flush operation (S160), memory space within the random write cache 120 is now available, and the current received write data (having previously been determined to be random write data) may be written to the random write cache 120 by the host driver 240 (S170).

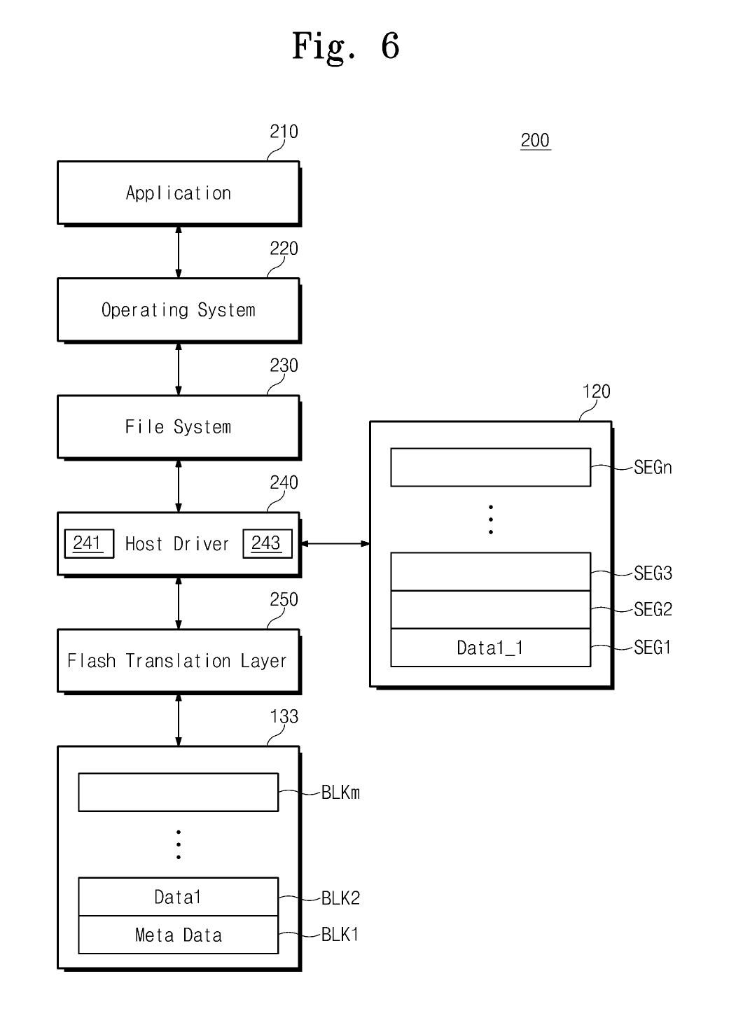

The example illustrated in FIG. 6 sequentially follows the example of FIG. 5 and assumes that following the receipt and writing of first and second received write data to the first and second memory blocks (BLK1 and BLK2) of the flash memory 133, a plurality of random write data is received and written to fill all of the segments of the random write cache 120. This plurality of random write data includes a “target random write data” (Data1_1) written to a first segment SEG1 of the random write cache 120. The target random write data Data1_1 is further assumed to be random write data updating the second write data (Data1) already stored in the second memory block of the flash memory 133.

Now, given the foregoing assumptions that the random write cache 120 is full, it is further assumed that a next random write data (e.g., Data1_2) is received. Since the random write cache 120 is full, the user device 100 of FIGS. 1 and 2 will perform a flush operation before the next random write data can be stored in the random write cache 120. This flush operation, as executed within embodiments of the inventive concept, avoids the conventional outcome of generating many invalid memory blocks in flash memory 133 and the resulting high memory system overhead.

That is, the user device 100 according to the illustrated embodiment of the inventive concept comprises the random write cache 120 to temporarily store all received random write data. Extending the working example described through FIG. 6, space within the random write cache 120 must be made available in order to store the next received write data (Data1_2). Memory allocation within various embodiments of the inventive concept may proceed along different determinations. For example, if a flush operation transferring the target random write data Data1_1 to the flash memory 133 is sufficient in and of itself to free up memory space to store the next received write data Data1_2, then only the first segment SEG1 of the random write cache 120 need be flushed. However, if the next received write data has a size exceeding the memory space allocated to the first segment SEG1, then additional segments of the random write cache 120 must be flushed.

Since the target random write data Data1_1 will update existing data stored in the flash memory 133, its transfer will induce some memory operating overhead related to the flash memory 133. Such overhead for the flash memory 133 may include block erasing, data updating and writing, and may increase the executed number of a background operation such as garbage collection or merge. After such overhead operations, the target random write data Data1_1 stored in the random write cache 120 may be flushed to the flash memory 133.

In a case where data has locality (i.e., is related to previously stored data), updating of said data, that is, random writing may be collectively performed with respect to the specific data. The user device 100 illustrated in FIG. and operated according to an embodiment of the inventive concept may write random write data in the random write cache 120. Thus, it is understood that random writing to the flash memory 133 may be replaced with random writing to the random write cache 120 in the event that data has locality.

For example, if the target write data Data1_1 corresponds to data written at a specific page (e.g., a first page) of a specific memory block (e.g., BLK2) at which existing data (e.g., Data1) is already stored, the random write data as determined by the host driver 240 may nonetheless be written to a segment (e.g., a first segment SEG1) of the random write cache 120. Subsequently, if another random write data has the same locality definition (e.g., further updates the data stored at the first page of the second block BLK2 of the flash memory 133), the host driver 240 may first cause the transfer of the target write data Data1_1 stored in the first segment SEG1 of the random write cache 120 before storing the next write data (e.g., Data1_2) having the same locality. Thus, in certain embodiments of the inventive concept, since the random write cache 120 is implemented as a random access memory, the user device 100 may reduce overhead due to random writing using the random write cache 120 in the event of a high incidence of write data locality.

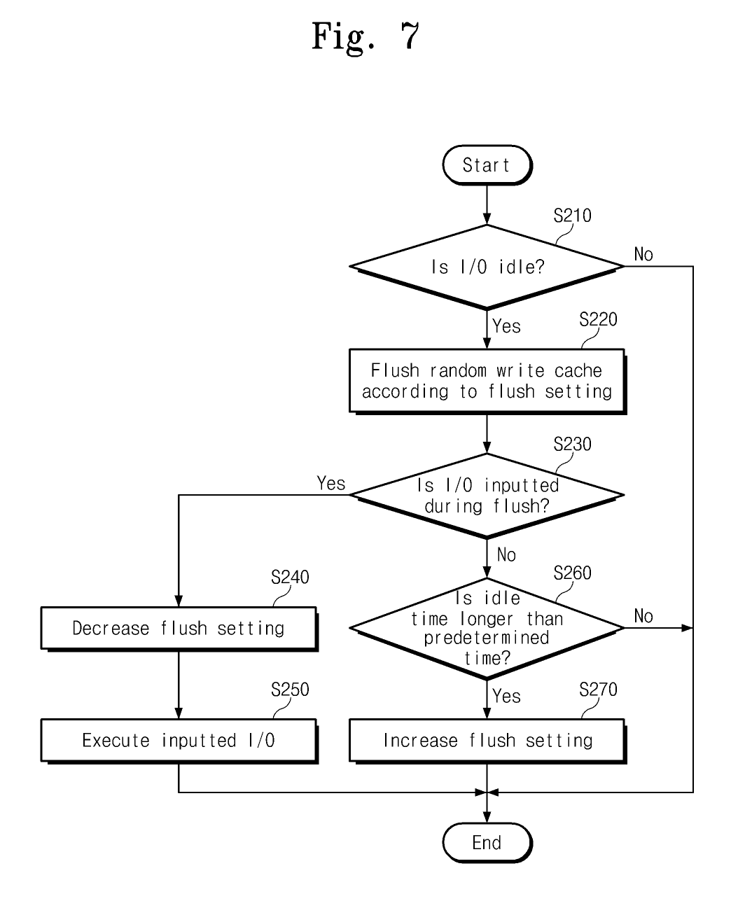

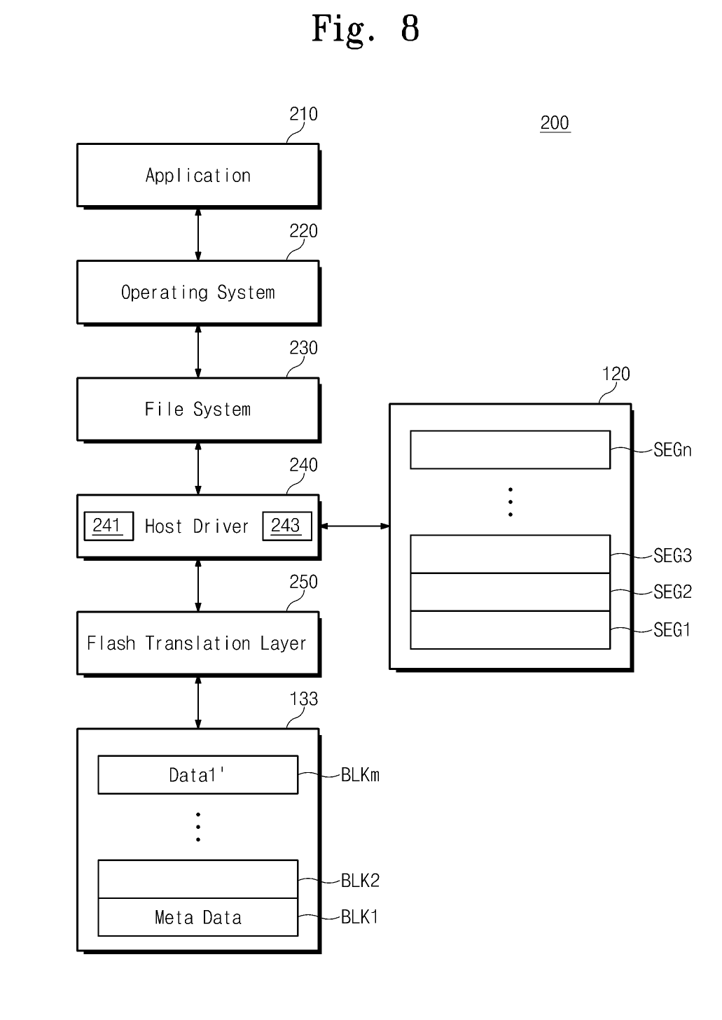

An exemplary flush operation executable by certain embodiments of the inventive concept will now be described in some additional detail with respect to FIGS. 7 and 8. Referring to FIGS. 1, 2, and 7, the flush controller 243 of the host driver 240 first determines the I/O state of the flash memory 133 (S210). If the flash memory 133 is idle (S210=YES), the random write cache 120 is flushed (e.g.) according to flush control settings (S220). One or more segments in the random write cache 120 may be flushed to the flash memory 133, as defined by the flush settings. For example, extending the working example described in relation to FIG. 6 and considering FIG. 8, the target write data Data1_1 stored in the first segment SEG1 of the random write cache 120 and updating the second write data Data1 stored in the second memory block of the flash memory 133 may be flushed to the flash memory 133 to make memory space available in the random write cache 120 for a next write data Data1_2. This example assumes that the first segment is sufficient in size to store the next write data Data1_2. Otherwise, multiple segments of the random write cache 120 would be flushed.

It should be noted at this point that within certain embodiments of the inventive concept, the flush controller 243 may be used to dynamically control memory space allocation within the random write cache 120. That is, random write data may be shifted between various segments to maximize memory space usage and minimize the occurrence of the random write cache 120 being full.

For example, multiple update to a same memory location in the flash memory 133 may be efficiently handled by the random write cache 120 under the control of the flush controller 243. Assuming three random write data entries to the random write cache 120 all directed to data stored in the same memory block of the flash memory 133, only a single flush operation is needed to one-time update the identified memory block. The multiple random write data entries might be grouped into a single segment or written across multiple segments. Where multiple segments are necessary to store multiple random write data being written to a single flash memory block, the flush operation may cause the multiple segments to be flashed accordingly. This ability reduces memory system overhead due to multiple random write data operations.

Returning to FIG. 7, during the execution of the flush operation, the host driver 240 may determine whether a data access operation (i.e., an I/O command is received) interrupts the flush operation (S230). In response to a determination that a data access operation is interrupting the flush operation (S230=YES), the user device 100 pauses execution of the interrupting data access operation until the flush operation is completed. However, the host driver 240 may adjust the current flush setting (e.g., decrease the number of segments being transferred during the flush operation by decreasing a flush setting value) to more rapidly complete the ongoing flush operation (S240).

Once the flush operation (albeit in an abbreviated form) is completed, the interrupting data access operation is executed (S250). The flush setting may be reset for a subsequent flush operation.

However, if the flush operation is not interrupted (S230=NO), then a determination is made by the host driver 240 as to whether the idle period is longer than expected (S260). If the idle period is extended (S260=YES), then the scope of an ongoing flush operation may be extended by increasing the current flush setting value. (S270). An extended flush operation will allow more segments in the random write cache 120, if needed, to be flushed. If not, the flush operation will terminate normally (S260=NO). The flush setting may be adjusted during subsequent flush operations.

If the number of segments to be flushed at once is reduced, the reduction of overhead due to random write data is reduced. It is assumed that one segment is flushed to the flash memory 133 from the random write cache 120 at once. Further, it is assumed that a first target write data Data1_1 stored in a first segment SEG1 updates the second data Data1 stored in the second memory block of the flash memory 133 and a second target write data Data1_2 stored in a second segment SEG2 also updates the second data Data1 stored in the second memory block of the flash memory 133. Then, during the flush operation only one of the segments (SEG1 or SEG2) may be flushed from the random write cache 120, and full update of the second data Data1 in flash memory 133 requires two flush operations.

On the other hand, if two segments may be flushed during a single flush operation from the random write cache 120 to flash memory 133, both the first and second target write data, Data1_1 and Data1_2, may be flushed via one flush operation. That is, it may be understood from the foregoing that given a certain number of random write operations directed to flash memory 133, the number of write operations actually executed in relation to the flash memory 133 in embodiments of the inventive concept becomes a product of the number of segments being flushed during a single flush operation. By increasing the number of flushed segments during a single flush operation, the data access operations performed by the flash memory 133 may be reduced, thereby sparing the constituent memory cells from wear.

There are certain user device design tradeoffs that should be considered. Since the random write cache 120 is implemented as volatile memory, any loss of applied power will cause a loss of stored random write data. By increasing available segments (and expanding the size of the random write cache 120) the risk of losing more random write data due to a loss of power increases accordingly.

Further, if the number of segments to be flushed at once is increased, the time required to perform a flush operation also increases. During relatively long flush operations, the risk of an interrupting data access operation to flash memory 133 increases and must be held for a longer period of time. Thus, at some level an expanded number of segments to be flushed during a flush operation may actually increase memory system overhead.

The user device 100 illustrated in the foregoing embodiments may, thus, be configured to adjust the number of segments to be flushed during a flush operation in real-time response to available idle time for the flash memory 133. As noted in the example, above, if an interrupting data access operation to the flash memory 133 arises during a flush operation, the number of segments to be flushed may be reduced to avoid an overly long delay period for the interrupting data access operation. Similarly, the ability to expand the number of segments flushed during a single flush operation being executed during an extended idle period reduces the risk of storing too much random write data for too long and possibly losing the data to a sudden power-off event.

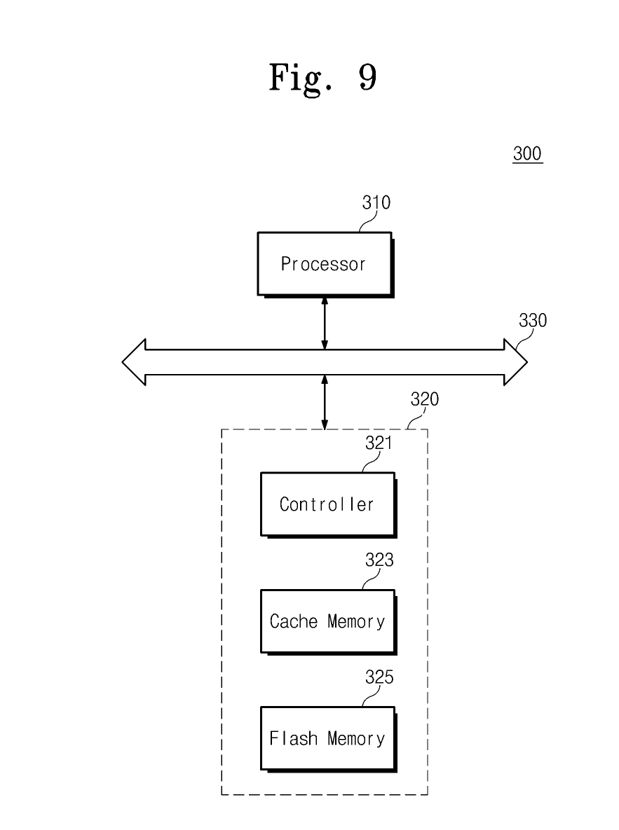

FIG. 9 is a block diagram of a computational system according to another embodiment of the inventive concept. Referring to FIG. 9, the computational system 300 comprises a processor 310, a user device 320, and a system bus 330 facilitating data communication between the processor 310 and user device 320. The processor 310 processes data and may be configured to control the overall operation of the computational system 300.

The user device 320 comprises a controller 321 for controlling an overall operation of the user device 320, a cache memory 323 for storing random write data of write data to be written in the flash memory 325, and a flash memory 325. In FIG. 9, the controller 321 and the cache memory 323 are illustrated to be independent elements. But, it is comprehended that the controller 321 and the cache memory 323 are integrated as one element of the user device 320.

The user device 320 may operate in the same manner as that described with reference to FIGS. 1 to 8. For example, the user device 320 may write in the cache memory 323 random write data of write data to be written in the flash memory 325. If the flash memory 325 is at an idle state, the user device 320 may flush data from the cache memory to the flash memory 325. The user device 320 may be configured to adjust the number of segments to be flushed at once by comparing a time taken to perform a flush operation with an idle time of the flash memory 325.

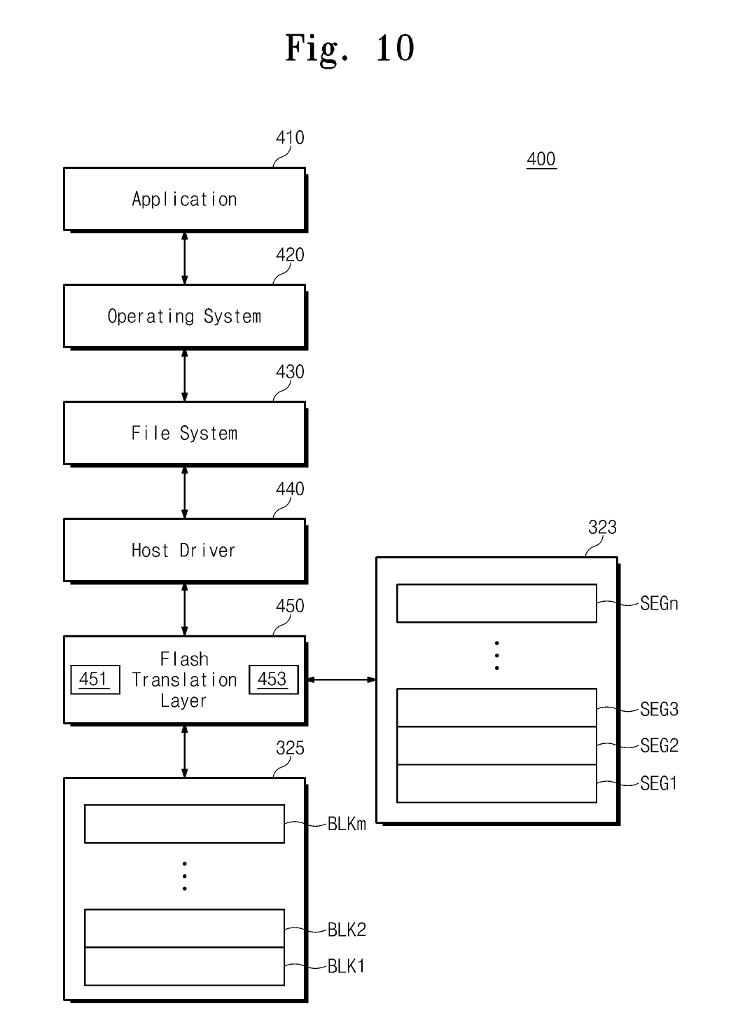

FIG. 10 is a block diagram showing a software layer within the computational system of FIG. 9. Referring to FIGS. 9 and 10, a software layer 400 within the computational system 300 may comprise an application 410, operating system 420, file system 430, host driver 440, flash translation layer 450, cache memory 323, and flash memory 325. The layers 410 to 430 are identical to those described with reference to FIGS. 1 to 8, and description thereof is thus omitted.

The host driver 440 may be a driver for controlling the user device 320. The host driver 440 may be driven by the processor 310 of the computing system 300.

The flash translation layer 450 may include mapping information for translating into physical addresses of the flash memory 325 logical addresses which sent from the application 410, the operating system 420, the file system 430, and the host driver 440 to access the flash memory 133. The flash translation layer 450 may be configured to translate logical addresses into physical addresses of the flash memory 325 using the mapping information. For example, the flash translation layer 450 may be configured to perform background operations such as garbage collection and merge. The flash translation layer 450 may be driven by the controller 321.

The flash translation layer 450 may include a filter 451 for determining whether transferred write data is sequential write data or random write data, and a flush controller 453 for controlling a flush operation for storing data of the cache memory 323 in the flash memory 325.

The flash translation layer 450 may be configured to access the cache memory 323. If write data to be written in the flash memory 325 is judged to be random write data via the filter 451, the flash translation layer 450 may write in the cache memory 323 write data to be written in the flash memory 325. In an exemplary embodiment, if an input/output command for the flash memory 325 is at an idle state, for example, when the flash memory 325 is at an idle state, the flush controller 443 of the flash translation layer 450 may flush data from the cache memory 323 to the flash memory 325.

The cache memory 323 may include a plurality of segments SEG1 to SEGn, each of which is configured to store data judged to be random write data via the filter 453. If an input/output command for the flash memory 325 is at an idle state, for example, when the flash memory 325 is at an idle state, the flush controller 453 may flush into the flash memory 325 data stored in the predetermined number of segments.

The user device 320 may be configured to adjust the number of segments to be flushed. In an exemplary embodiment, the cache memory 323 may be a volatile random access memory such as DRAM, SRAM, SDRAM, and the like or a non-volatile random access memory such as PRAM, MRAM, FRAM, and the like.

Although not illustrated in figures, the flash memory 325 may include a memory cell array, an address decoder, a page buffer (or, a page register), a column selector, a data input/output circuit, and the like. Alternatively, the flash memory 325 may include a memory cell array, an address decoder, a sense amplifier, a write driver, a column selector, a data input/output circuit, and the like.

An operation described with reference to FIGS. 3 and 7 may be performed by the flash translation layer 450, the filter 451, and the flush controller 453 described with reference to FIGS. 9 and 10.

In an exemplary embodiment, a random write cache 120 in FIGS. 1 to 8 may correspond to a cache memory 323 in FIGS. 9 and 10, a flash memory 133 in FIGS. 1 to 8 may correspond to a flash memory 325 in FIGS. 9 and 10, and an operation of a host driver 240 driven by a processor 110 in FIGS. 1 to 8 may correspond to an operation of the flash translation layer 450 driven by a controller 321 in FIGS. 9 and 10.

The user device 320 according to the present inventive concept may write in the cache memory 323 random write data of write data to be written in the flash memory 325. If the flash memory 325 is at an idle state, the user device 320 may flush data from the cache memory to the flash memory 325.

The user device 320 may be configured to adjust the number of segments to be flushed at once by comparing a time taken to perform a flush operation with an idle time of the flash memory 325. It is possible to improve a random write speed associated with the flash memory 325.

In an exemplary embodiment, the user device 320 may be configured to communicate with an external device (for example, a system bus 330 or a computing system 300) via one of various interface protocols such as USB, MMC, PCI-E, ATA, SATA, PATA, SCSI, ESDI, and IDE.

The controller 321, the cache memory 323, and the flash memory 325 may be integrated to form one semiconductor device. For example, the controller 321, the cache memory 323, and the flash memory 325 may be integrated to form a memory card. Alternatively, the controller 321, the cache memory 323, and the flash memory 325 may be integrated to form PCMCIA, CF, SM/SMC, memory stick, MMC, RS-MMC, MMCmicro, SD, miniSD, microSD, UFS, and the like. Alternatively, the controller 321, the cache memory 323, and the flash memory 325 may be integrated to form a solid state drive/disk (SSD). If the user device 320 is used as the SSD, an operating speed of a device connected with the user device 320 may be improved remarkably.

In another embodiment, the user device 320 may be applied to a computer, portable computer, UMPC, workstation, net-book, PDA, web tablet, wireless phone, mobile phone, smart phone, digital camera, digital audio recorder/player, digital picture/video recorder/player, a device capable of transmitting and receiving information at a wireless circumstance, one of various electronic devices constituting home network, one of various electronic devices constituting computer network, one of various electronic devices constituting telematics network, or one of various electronic devices constituting computing system such as SSD or memory card.

In another embodiment, a flash memory 325 or a user device 320 may be packed by various packages such as PoP(Package on Package), Ball grid arrays(BGAs), Chip scale packages(CSPs), Plastic Leaded Chip Carrier(PLCC), Plastic Dual In-Line Package(PDIP), Die in Waffle Pack, Die in Wafer Form, Chip On Board(COB), Ceramic Dual In-Line Package(CERDIP), Plastic Metric Quad Flat Pack(MQFP), Thin Quad Flatpack(TQFP), Small Outline(SOIC), Shrink Small Outline Package(SSOP), Thin Small Outline(TSOP), Thin Quad Flatpack(TQFP), System In Package(SIP), Multi Chip Package(MCP), Wafer-level Fabricated Package(WFP), Wafer-Level Processed Stack Package(WSP), or the like.

The above-disclosed subject matter is to be considered illustrative, and not restrictive, and the appended claims are intended to cover all such modifications, enhancements, and other embodiments, which fall within the true spirit and scope. Thus, to the maximum extent allowed by law, the scope is to be determined by the broadest permissible interpretation of the following claims and their equivalents, and shall not be restricted or limited by the foregoing detailed description.

What is claimed is:

1. A user device comprising:
a flash memory, a random write cache, and a processor connected via a system bus, wherein the processor is configured to control operation of the flash memory and the random write cache, and further configured to:
receive write data to be written in the flash memory;
determine whether the received write data is random write data or sequential write data;
if the received write data is sequential write data, then directly writing the received write data to the flash memory, and
if the received write data is random write data, then writing the received write data to the random write cache; and
flushing the random write data from the random write cache to the flash memory during idle periods for the flash memory.

2. The user device of claim 1, wherein the processor is further configured to determine whether the received write data is meta data, and if the received write data is meta data, then directly writing the received write data to the flash memory.

3. The user device of claim 1, wherein the random write cache is divided in a plurality of segments, each storing random write data; and
flushing the random write data from the random write cache to the flash memory comprises flushing the random write data stored in a number of segments on a segment by segment basis.

4. The user device of claim 3, wherein the number of segments flushed during the flush operation is defined by a flush setting, and
the processor is further configured to adjust a value of the flush setting in response to a length of an idle period.

5. The user device of claim 4, wherein if the idle period is longer than a predetermined time, the value of the flush setting is increased.

6. The user device of claim 4, wherein if the idle period is interrupted by a data access operation to the flash memory, the value of the flush setting is deceased and the interrupting data access operation is held by the processor until flushing the random write data from the random write cache to the flash memory is completed.

7. The user device of claim 4, wherein an interrupting data access operation is detected upon receiving in the processor an input/output command associated with data to be written to the flash memory.

8. The user device of claim 3, wherein the processor is further configured to determine whether the random write cache is full upon receiving write data, and if the random write cache is full, then flushing the random write data from the random write cache to the flash memory.

9. The user device of claim 8, wherein flushing the random write data from the random write cache to the flash memory comprises flushing a least recently accessed segment among the plurality of segments.

10. The user device of claim 1, wherein the flash memory, the random write cache, and the processor constitute a solid state drive (SSD).

11. The user device of claim 1, wherein the flash memory, the random write cache, and the processor constitute a memory card.

12. A method of writing data to a flash memory in a system, the system comprising the flash memory, a random write cache, and a processor connected via a system bus, the method comprising:
receiving write data to be written in the flash memory;
determining whether the received write data is random write data or sequential write data;
if the received write data is sequential write data, then directly writing the received write data to the flash memory, and if the received write data is random write data, then writing the received write data to the random write cache; and
flushing the random write data from the random write cache to the flash memory during idle periods for the flash memory.

13. The method of claim 12, further comprising:
determining whether the received write data is meta data, and if the received write data is meta data, then directly writing the received write data to the flash memory.

14. The method of claim 12, wherein the random write cache is divided in a plurality of segments, and flushing the random write data from the random write cache to the flash memory comprises flushing the random write data stored in a number of segments on a segment by segment basis.

15. The method of claim 14, further comprising defining the number of segments flushed during the flush operation according to a flush setting, and
adjusting a value of the flush setting in response to a length of an idle period.

16. The method of claim 15, wherein if the idle period is longer than a predetermined time, the value of the flush setting is increased.

17. The method of claim 15, wherein if the idle period is interrupted by a data access operation to the flash memory, the value of the flush setting is deceased and the method further comprises;
holding the interrupting data access operation until the flushing of the random write data from the random write cache to the flash memory is completed.

18. The method of claim 15, further comprising:
detecting the interrupting data access operation upon receiving an input/output command associated with data to be written to the flash memory.

19. The method of claim 14, further comprising:
determining whether the random write cache is full upon receiving write data, and if the random write cache is full, then flushing the random write data from the random write cache to the flash memory.

20. The method of claim 19, wherein flushing the random write data from the random write cache to the flash memory comprises flushing a least recently accessed segment among the plurality of segments.
